(19) United States
(12) Patent Application Publication
(10) Pub. No.: US 2014/0302953 A1
(43) Pub. Date: Oct. 9, 2014

(54) Table tennis racquet and method of production

(71) Applicant: KETTLER INTERNATIONAL, INC., Virginia Beach, VA (US)

(72) Inventor: Joachim Kettler, Ense (DE)

(73) Assignee: KETTLER INTERNATIONAL, INC., Virginia Beach, VA (US)

(21) Appl. No.: 13/874,166

(22) Filed: Apr. 30, 2013

(30) Foreign Application Priority Data
Apr. 3, 2013 (DE) 10 2013 103 304.0

(51) Int. Cl. A63B 59/04; B29C 45/16

(52) U.S. Cl. CPC A63B 59/04; B29C 45/1615; B29C 45/1679
USPC 473/527; 264/254

(57) ABSTRACT

A table tennis racquet (1), particularly a weather resistant table tennis racquet (1) comprising a plate-like base body (2), a first playing surface (5) made of a first plastic and is injection molded to a side of the base body (2) and a second playing surface (6) made of a second plastic is injection molded to another side of the base body (2). The first playing area (5) on a first side the basic body (2) and the second playing area (6) on a second side opposite the first side of the base body (2).

### FIELD OF THE INVENTION

The present invention relates to a method for producing a table tennis racquet, in particular a weather resistant table tennis racquet. Weather resistant table tennis racquets are particularly suitable for use with table tennis tables that are used outdoors.

An object of the present invention is to provide embodiments of a table tennis racquet and a method of producing table tennis racquets, especially a weather resistant table tennis racquet, of robust quality, a variety of playability features, and/or with a visually appealing look and structure. Further, embodiments of a method for producing table tennis racquets are described. Embodiments of the methods may be carried out particularly effectively and inexpensively.

### SUMMARY

According to the invention, embodiments of a method for producing a table tennis racquets comprises producing a plate-shaped base body in a first injection molding process, coating the plate-shaped base body on a first playing surface side with a first polymeric material in a third injection molding process, and coating the plate-shaped base body on a second playing surface side opposite the first playing surface side with a second polymeric material in a fourth injection molding process.

Further according to the invention, embodiments of a table tennis racquet comprising a plate-shaped base body, a first playing surface consisting of a first injection molded plastic on a first side of the base body and a second playing surface consisting of a second injection molded plastic on a second side of the base body, wherein the second side is opposite of the first side on the base body. In certain embodiments, the color of the first injection molded plastic is different than a color of the second injection molded plastic.

According to an embodiment of the method of producing a table tennis racquet, a plate-shaped base body is produced. Subsequently, in a further process step, the plate-shaped base body is at least partially coated on a first side with a first polymeric material, such as a plastic, to produce a first playing surface. In a further process step, the plate-shaped base body is at least partially coated on a second side with a second polymeric material, such as a plastic, producing a second playing surface.

In at least one embodiment, the table tennis racquet comprises a first playing surface having a first color and the second playing surface having a second color, wherein the first color of the first playing surface is different than the color of the second playing surface. In embodiments, where the first color is different that the second color, the table tennis racquet has a visually appealing appearance. In further embodiments, the first polymeric material is different than the second polymeric material in at least one chemical or physical property. For example, one of the playing surfaces may comprise a polymeric material that is softer and/or more pliable than the polymeric material of the other playing surface. In still further embodiments, the first playing surface and the second playing surface may have distinct structures, so that they also have distinct game playing properties. For example, one of the playing surfaces may be relatively smooth, while the other playing surface comprises structures, for example, knobs or pips. In other embodiments, the first playing surface comprises different structures than the second playing surface.

In other embodiments, after the production of the base body and before the application of the playing surfaces, the method comprises attaching a handle to the base body in a second injection molding process. In additional embodiments, attaching the handle may occur after coating one or both playing surfaces on the base body. A base body attached to a handle without playing surfaces attached is typically referred to as a blade in table tennis.

In certain embodiments, producing the base body and/or attaching the handle and/or the coating with the playing surfaces are performed by plastic injection molding process. In a more particular embodiment, producing the base body, attaching the handle, and at least partially coating the base body with the playing surfaces are all performed by different plastic injection molding processes and in different injection molds. The injection molding of the components allows efficient large-volume manufacturing of the table tennis racquets and, if desired, use of separate materials for each component of the table tennis racquet. In certain embodiments, the individual components are connected together during each of the injection molding processes so that a simple robust structure of table tennis racquet is produced. Further, by using four different injection molding processes, each of the components, the base body, the handle, the first playing surface and the second playing surface may comprise different polymeric materials. The four different polymeric materials may each have different physical or chemical properties or some of the components may be formed with similar or identical polymeric materials.

For example, any of the polymeric materials may be different than the other polymeric material incorporated in the components of the table tennis racquet. A polymeric material may differ from another polymeric material in at least one physical property such as, but not limited to, density, resilience, hardness, elongation, tensile strength, for example, or a chemical property such as, but not limited to, chemical composition, polymer structure, polymer blend, plasticizer content, colorant, processing additives, fillers, for example. The polymeric material may be a natural rubber, synthetic rubber or a blend of natural or synthetic rubbers.

There are many advantages to having the ability to form each component of the table tennis racquet in a different injection molding process. For example, the playing surfaces may be formed with different polymeric materials. Each injection molding process could use a different polymeric resin to form the playing surface on each side of the base body. Different polymeric materials may have different playability properties and/or colors, for example. Further, by forming the base body in a different injection molding process than the handle, the balance of the racquet may easily be controlled by using polymeric materials of different densities. Still further, a stiff rigid base body may be formed with a softer more comfortable handle. The different properties of the handle and the base body will also allow tuning of the playability of the racquet for offensive or defensive playing styles, for example.

It can be provided that the base body can be produced in a first injection mold and attaching of the handle to the base body be performed in a second injection mold, wherein the second injection mold is different from the first injection mold.

Further, it may be provided that the plastic injection molding for the coating of the base body with the first polymeric material of the first playing surface is in a third injection mold and the plastic injection molding for the coating of the base body with the second polymeric material of the second playing surface is performed in a fourth injection mold. In a particular embodiment, the third and fourth injection molds are different molds. By the use of two unique injection molds for the two different playing surfaces, the playing surfaces may be separately produced with different colors, materials and/or structures. This also allows more versatile manufacturing process and the option to have many more playing surface combinations than using a single mold to coat both playing surfaces. For example, with three molds for a single side of the table tennis racquet, six combinations of table tennis racquets with different playing surfaces may be made, wherein with three double sided molds only three playing surface combinations can be produced.

In one embodiment, the base body, after being removed from the first injection mold, is placed in the second injection mold to attach a handle to the base body in a second injection molding process. After the second injection molding for attaching the handle to the base body, the base body with the handle is removed from the second injection mold and placed in a third injection mold for molding of the first playing surface. After the molding of the first playing surface, the base body with the handle is removed from the third injection mold and placed into the fourth injection mold for coating the second playing surface. After coating the second playing surface, the table tennis racquet is removed from the fourth injection mold. This production of a table tennis racquet in four mutually different injection molds can produce inventive and high quality table tennis racquets at a high production rate. Further embodiments include a table tennis racquet. The table tennis racquet may comprise a plate-shaped base body, a first playing surface consisting of a first injection molded plastic on a first side of the base body, wherein the first plastic has a first color; and a second playing surface consisting of a second injection molded plastic on a second side of the base body opposite of the first side, wherein the second plastic has a second color which is different than the first color.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of components, parts, techniques and steps are disclosed. Each of these has individual benefit and each can also be used in conjunction with one or more, or in some cases, all of the other disclosed embodiments and techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### BRIEF DESCRIPTION OF THE FIGURES

Further features and advantages of the present invention will become clear from the following description of preferred embodiments with reference to the accompanying figures, wherein:

FIG. 1 shows a side view of an embodiment of the table tennis racquet; and

FIG. 2 shows the side view of the table tennis racquet of FIG. 1 rotated by 90° according to the arrow II in FIG. 1.

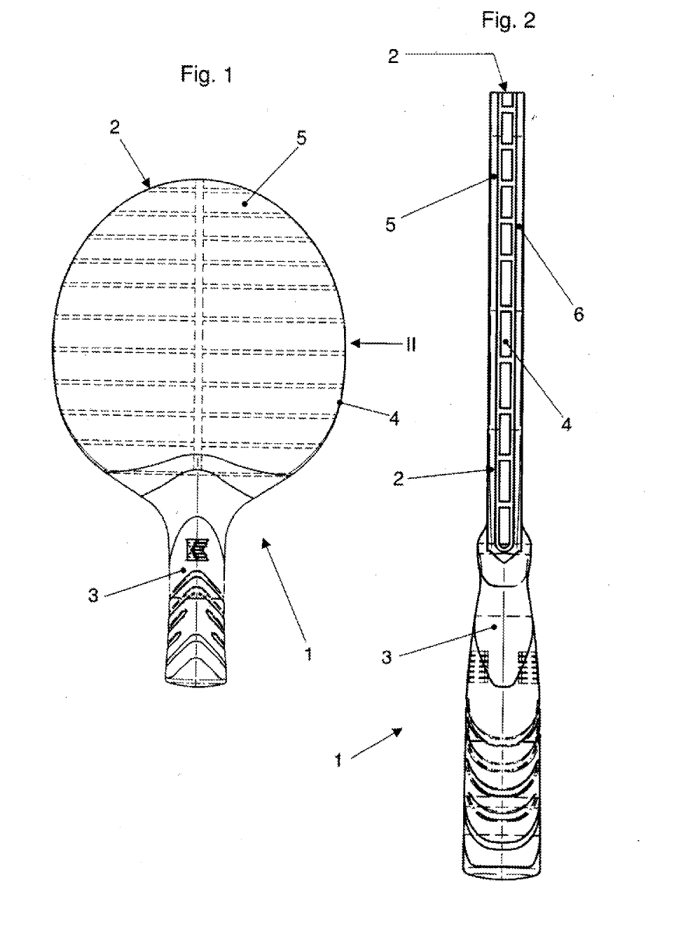

### DESCRIPTION OF EMBODIMENTS OF THE INVENTION

In the figures, identical or functionally identical components are identified with the same, reference numerals.

The table tennis racquet 1 comprises a flat plate-shaped, base body 2 with a substantially circular or an oval outline. A handle 3 extends outward from the base body 2 to form the blade. The body 2 may have at least one outward surface and has channels creating recesses 4 within the body. The channels provide stability of the base body 2 and simultaneously increase or decrease its weight as desired by modifying the size of the recesses. The weight of the base body relative to the handle may also be altered by changing the composition of the polymeric material. Also the overall flexibility of the blade can be tuned in this same manner.

Coated on each of the two flat sides of the base body 2 are two playing surfaces 5, 6. Here, the first playing surface 5, which disposed on the left side in FIG. 2, comprises a first polymeric material. The first polymeric material may comprise a first set of physical properties such as, but not limited to, density, resilience, hardness, softness, pliability, elongation, and tensile strength, for example, and a first set of chemical properties such as, but not limited to, chemical composition, polymer structure, polymer blend, plasticizer content, colorant, processing additives, and/or fillers, for example. The polymeric material may be a natural rubber, synthetic rubber or a blend of natural or synthetic rubbers. The first polymeric material may comprise a first color, for example, a red color. Furthermore, the second playing surface 6, which is disposed on the right side in FIG. 2, comprises a second polymeric material. The second polymeric material may comprise different physical and/or chemical properties from the first polymeric material. The polymeric materials may comprise a homopolymer, copolymer, or a blend of homopolymers and/or copolymers.

In certain embodiments, the playing surfaces 5, 6 comprise different materials and/or distinct structures, so that each of the playing surfaces has distinct game playing properties. For example, one of the playing surfaces 5, 6 may comprise a softer and/or more pliable polymeric material than the other of the playing surfaces 5, 6. Further, one of the playing surfaces 5, 6 may comprise different surface characteristics than the other playing surface. The play surface characteristics may include, but are not limited to, a relatively smooth surface while the other of the playing surfaces 5, 6 may comprise structures such as pips. Further, the pips may be of different lengths or different shapes than the other side providing different playing characteristics to each playing surface.

In certain embodiments, the base 2, the handle 3, and play surfaces 5, 6 can be formed and connected as plastic injection-molded parts in injection molding processes. In particular, the individual components, the base body 2, the handle 3, the first playing surface 5, and the second playing surface 6 of the table tennis racquet 1 can by produced and connected by consecutive injection molding processes to produce the table tennis racquet.

In an embodiment of the method of producing a table tennis racquet, the base body 2 may be produced first from a first polymeric material in a first injection molding process in a first injection mold. Subsequently, the main body 2 is removed from the first injection mold.

The base body 2 is then placed in a second injection mold. The handle 3 is then produced and attached to the base body 2 from a second polymeric material in a second injection molding process in this second injection mold. Subsequently, the base body 2 together with the handle 3 attached thereto, the blade are removed from the second injection mold.

The main body 2 with the attached molded handle 3 is then placed in a third injection mold. The first playing surface 5 is coated on the base body 2 from a third polymeric material in a third injection molding process in a third injection mold. Thereafter, the base body 2 with the attached molded handle 3 and the molded first playing surface 5 are removed from the third injection mold.

The main body 2 with the molded handle 3 and the first playing surface 5 is then placed in a fourth injection mold. The second playing surface 6 is coated on the base body 2 from a fourth polymeric material in a fourth injection molding process in the fourth injection mold. Subsequently, the table tennis racquet 1 is removed from the fourth injection mold.

The embodiments of the described method for producing a table tennis racquet and table tennis racquets are not limited to the particular embodiments, components, method steps, and materials disclosed herein as such components, process steps, and materials may vary. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

1. A method for producing a table tennis racquet, the method comprising the following steps:
producing a plate-shaped base body;
coating the plate-shaped base body on a first playing surface side with a first polymeric material;
coating the plate-shaped base body on a second playing surface side opposite the first opposite the first playing surface side with a second polymeric material.

2. The method according to claim 1, after the producing the base body and before the coating of the playing surface side on the base body, attaching a handle to the base body.

3. The method according to claim 2, wherein at least one of producing the base body, the attaching the handle or the coating the playing surfaces (5, 6) is performed by plastic injection molding.

4. The method according to claim 3, wherein the producing the base body is conducted by a first injection molding process in a first mold and the attaching of the handle is conducted by a second injection molding process in a second mold to produce a blade.

5. The method according claim 4, wherein coating the plate-shaped base body on the first playing surface side is performed by a third injection molding process in a third mold and the coating the plate-shaped base body on the second playing surface side is performed by a fourth injection molding process in a fourth mold.

6. The method according to claim 5, wherein at least one physical structure of the third mold and the fourth mold are different.

7. The method according to one of claim 5, comprising:
removing the base body from the first mold after the first injection molding process,
placing the base body into the second mold and performing an injection molding process to attach a handle to the base body,
removing the base body with the handle from the second mold after the second injection molding process,
placing the base body with a handle into the third mold and performing a third injection molding process to provide a first playing surface,
removing the base body with the handle from the third mold after the third injection molding process; and
placing the base body with the handle into the fourth mold and performing a fourth injection molding process to provide a second playing surface.

8. Table tennis racquet, comprising:
a plate-shaped base body,
a first playing surface consisting of a first plastic injection molded onto a first side of the base body, wherein the first injection melded plastic is a first polymeric material; and
a second playing surface consisting of a second plastic injection molded onto a second side of the base body opposite of the first side, wherein the second injection molded plastic is a second polymeric material.

9. The table tennis racquet according to claim 8, wherein the base body consists of a third injection molded plastic, wherein the third injection molded plastic is a third polymeric material.

10. The table tennis racquet according to claim 8, comprising a handle consisting of an injection molded plastic, wherein the handle is attached to the base body by an injection molding process and the fourth injection molded plastic is a fourth polymeric material.

11. The table tennis racquet according to claim 10, wherein the third polymeric material has different chemical properties or physical properties than the fourth polymeric material.

12. The table tennis racquet of claim 8, wherein the first polymeric material has different chemical properties or physical properties than the second polymeric material.

13. The table tennis racquet of claim 8, wherein the first playing surface has different surface characteristics than the second playing surface.
